(19) United States
(12) Patent Application Publication
(10) Pub. No.: US 2008/0173632 A1
(43) Pub. Date: Jul. 24, 2008

(54) Pan sensor and heat generation unit having the pan sensor and cooking range having the heat generation unit and control method thereof

(75) Inventors: Seong Deog Jang, Suwon-si (KR); Seok Weon Hong, Yongin-si (KR); Sung Ho Lee, Hwaseong-si (KR); Min Su Jeon, Osan-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/878,150

(22) Filed: Jul. 20, 2007

(30) Foreign Application Priority Data
Jan. 20, 2007 (KR) 10-2007-6371

(51) Int. Cl. H05B 3/68; F24C 15/00; H05B 1/02

(52) U.S. Cl. 219/432; 219/447.1; 219/518

(57) ABSTRACT

A pan sensor capable of stably detecting the mounting of a cooking pan without error, a heat generation unit having the pan sensor, a cooking range having the heat generation unit and a control method thereof are disclosed. The cooking range includes a top plate for mounting a cooking pan thereon, one or more radiant heaters installed in the top plate for supplying heat to the cooking pan, one or more pan sensors, respectively installed in the radiant heaters, for sensing the presence of the cooking pan, each pan sensor having a sensor ring for detecting variation in electrostatic capacitance depending on whether the cooking pan is present, and a controller for controlling each radiant heater based on a sensor output value of each pan sensor.

### CROSS-REFERENCE TO RELATED APPLICATIONS

This application claims the benefit of Korean Patent Application No. 2007-0006371, filed on Jan. 20, 2007 in the Korean Intellectual Property Office, the disclosure of which is incorporated herein by reference.

### BACKGROUND

1. Field

The present invention relates to a pan sensor, a heat generation unit having the pan sensor, a cooking range having the heat generation unit and a control method thereof, and more particularly to a pan sensor capable of stably detecting the mounting of a cooking pan, a heat generation unit having the pan sensor, a cooking range having the heat generation unit and a control method thereof.

2. Description of the Related Art

There are various types of cooking ranges used for cooking food, for instance, a microwave oven using high-frequency waves, a gas or electric oven using a burner or heater and the like.

The electric oven includes an oven unit for heating and cooking food in a sealed state and a cooktop unit for mounting a cooking pan containing food on a heater to directly heat and cook the food, where the oven unit and the cooktop unit are united as a single body. The cooktop unit includes a plurality of heat generation units for emitting heat and a top plate on which the heat generation units are disposed.

The heat generation unit detects whether the cooking pan is mounted on the top plate by using a radiant heater having an electric sensor disposed under the top plate formed of glass or ceramic.

However, since the radiant heater having the electric sensor detects mounting of the cooking pan by using a relation equation based on a sensing value obtained by applying high-frequency waves to a loop-shaped ring, a detection error may occur depending on the location of the cooking pan. Further, an additional circuit should be installed to perform signal processing based on the sensing value, thereby complicating the circuit and increasing the manufacturing cost.

### SUMMARY

The present invention has been made in order to solve the above problems. It is an aspect of the invention to provide a pan sensor capable of stably detecting mounting of a cooking pan without error by performing a digital on/off operation, a heat generation unit having the pan sensor, a cooking range having the heat generation unit and a control method thereof.

Additional aspects and/or advantages of the invention will be set forth in part in the description which follows and, in part, will be apparent from the description, or may be learned by practice of the invention. In accordance with an aspect of the invention, there is provided a pan sensor including a sensor supporting unit installed in a radiant heater for supplying heat to a pan; and a detection unit connected to the sensor supporting unit to generate a sensing signal depending on whether the pan is present, the detection unit having a sensor ring for sensing the pan.

The sensor ring may sense whether there is a pan by detecting variation in electrostatic capacitance through contact with the pan.

The sensor ring may include a sensor coil formed in a multi-arc shape to cover the radiant heater.

The pan sensor may be a digital on/off switch for outputting a high-level or low-level sensor output value according to the variation in electrostatic capacitance.

The pan sensor may further include a lead wire for transmitting the high-level or low-level sensor output value according to the variation in electrostatic capacitance.

The lead wire may be electrically connected to ground potential by using a shielded wire.

The pan sensor may further include a terminal for connecting the sensor ring with the lead wire.

In accordance with another aspect of the invention, there is provided a heat generation unit including a cooking pan; a radiant heater for supplying heat to the cooking pan; and a pan sensor installed in the radiant heater for sensing the cooking pan, the pan sensor having a sensor ring for detecting variation in electrostatic capacitance depending on whether the cooking pan is present.

The pan sensor may output a high-level or low-level sensor output value according to variation in electrostatic capacitance by electrically connecting the sensor ring to ground potential.

In accordance with yet another aspect of the invention, there is provided a cooking range including a top plate for mounting a cooking pan thereon; one or more radiant heaters installed in the top plate for supplying heat to the cooking pan; one or more pan sensors, respectively, installed in the radiant heaters for sensing the cooking pan, each pan sensor having a sensor ring for detecting variation in electrostatic capacitance depending on whether the cooking pan is present; and a controller for controlling each radiant heater based on a sensor output value of each pan sensor.

The pan sensor may output a high-level or low-level sensor output value according to variation in electrostatic capacitance by electrically connecting the sensor ring to ground potential set in the cooking range.

The pan sensor may include a signal transmission unit for transmitting the high-level or low-level sensor output value corresponding to the variation in electrostatic capacitance to the controller.

The pan sensors may be installed in proportion to the number of the radiant heaters installed in the top plate, and each pan sensor provided in each radiant heater may be independently operated.

The controller may determine whether the cooking pan is mounted on the top plate based on the sensor output value of the pan sensor to control an operation of supplying power to the radiant heater.

When the pan sensor senses that there is a cooking pan, the controller may output a control signal for supplying power to the radiant heater to perform a cooking operation.

In accordance with another aspect of the invention, there is provided a heat generation unit including a cooking pan; a radiant heater for supplying heat to the cooking pan; and a pan sensor installed in the radiant heater for sensing the cooking pan, the pan sensor having a sensor ring for detecting variation in electrostatic capacitance depending on whether the cooking pan is present.

The pan sensor may output a high-level or low-level sensor output value according to variation in electrostatic capacitance by electrically connecting the sensor ring to ground potential.

In accordance with yet another aspect of the invention, there is provided a cooking range including a top plate for mounting a cooking pan thereon; one or more radiant heaters installed in the top plate for supplying heat to the cooking pan; one or more pan sensors, respectively, installed in the radiant heaters for sensing the cooking pan, each pan sensor having a sensor ring for detecting variation in electrostatic capacitance depending on whether the cooking pan is present; and a controller for controlling each radiant heater based on a sensor output value of each pan sensor.

The pan sensor may output a high-level or low-level sensor output value according to variation in electrostatic capacitance by electrically connecting the sensor ring to ground potential set in the cooking range.

The pan sensor may include a signal transmission unit for transmitting the high-level or low-level sensor output value corresponding to the variation in electrostatic capacitance to the controller.

The pan sensors may be installed in proportion to the number of the radiant heaters installed in the top plate, and each pan sensor provided in each radiant heater may be independently operated.

The controller may determine whether the cooking pan is mounted on the top plate based on the sensor output value of the pan sensor to control an operation of supplying power to the radiant heater.

When the pan sensor senses that there is a cooking pan, the controller may output a control signal for supplying power to the radiant heater to perform a cooking operation.

When the pan sensor senses that there is no cooking pan, the controller may output a control signal for blocking power supplied to the radiant heater to stop a cooking operation.

The cooking range may further include one or more power supply relays for performing an on/off operation according to the control signal outputted from the controller to supply power to the radiant heater or block power supplied to the radiant heater.

The power supply relays may be installed in proportion to the number of the radiant heaters installed in the top plate, and each power supply relay is independently operated according to a signal output value of the pan sensor provided in each radiant heater.

In accordance with yet another aspect of the invention, there is provided a control method of a cooking range including a cooking pan, a top plate, a radiant heater, a pan sensor and a controller, the method including sensing whether the cooking pan is mounted on the top plate by a pan sensor; supplying power to the radiant heater by the controller to perform a cooking operation when sensing that the cooking pan is mounted; and blocking power supplied to the radiant heater by the controller to stop the cooking operation when sensing that the cooking pan is not mounted while the cooking operation is operated.

The sensing may include detecting variation in electrostatic capacitance depending on whether there is the cooking pan in the pan sensor having a sensor ring to output a high-level or low-level sensor output value.

The sensing may include outputting a high-level or low-level sensor output value according to variation in electrostatic capacitance by electrically connecting the sensor ring to ground potential set in the cooking range.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a perspective view of a cooking range having a heat generation unit according to the present invention;

FIG. 2 shows a plan view of the heat generation unit having a pan sensor according to the present invention;

FIG. 3 shows a cross sectional view of the heat generation unit having the pan sensor installed in the cooking range according to the present invention;

FIG. 4 shows a circuit configuration of the cooking range including the heat generation unit according to the present invention; and

FIG. 5 is a flowchart showing an operation process of controlling power supply depending on whether the cooking pan is mounted in the cooking range including the heat generation unit according to the present invention.

### DETAILED DESCRIPTION OF THE EMBODIMENTS

Reference will now be made in detail to exemplary embodiments of the present invention, examples of which are illustrated in the accompanying drawings, wherein like reference numerals refer to like elements throughout. The embodiments are described below to explain the present invention by referring to the figures.

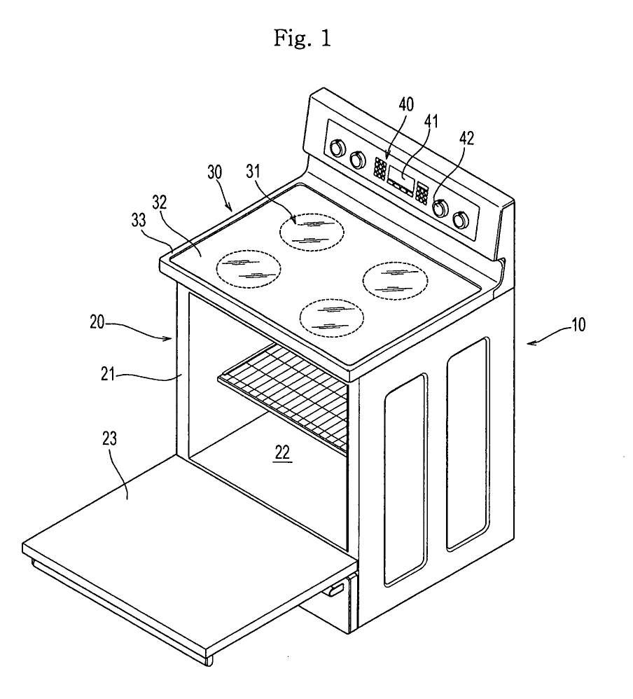

FIG. 1 is a perspective view of a cooking range having a heat generation unit in accordance with one embodiment of the present invention. As shown in FIG. 1, a cooking range 10 having a heat generation unit according to the present invention includes an oven unit 20 for heating and cooking food in a sealed state; a cooktop unit 30 disposed on the oven unit 20 for mounting a cooking pan containing food thereon to cook the food using a cooktop; and a control panel 40 disposed at a back side of the cooktop unit 30 such that a user can control the oven unit 20 and the cooktop unit 30.

The oven unit 20 includes a main body frame 21 forming a cooking chamber 22 that can be opened to accommodate the food through a front surface portion of the cooking chamber 22 and a door 23 hinged at one side of the main body frame 21 for opening/closing the cooking chamber 22.

The cooktop unit 30 includes a plurality of heat generation units 31 for heating the cooking pan by generating heat; a top plate 32 disposed on the main body frame 21 for arranging the heat generation units 31 thereon; and a cooktop frame 33 for surrounding the top plate 32. The top plate 32 for mounting the cooking pan thereon is disposed at an uppermost portion of the cooktop unit 30 and formed of ceramic or glass with a high heat resistance. Each heat generation unit 31 is a radiant heater module having a sensor to cook the food with radiant heat generated from a heating coil.

The control panel 40 includes a display unit 41 for displaying an operation state of the cooking range 10 and a plurality of control knobs 42 for controlling the operation of the cooking range 10.

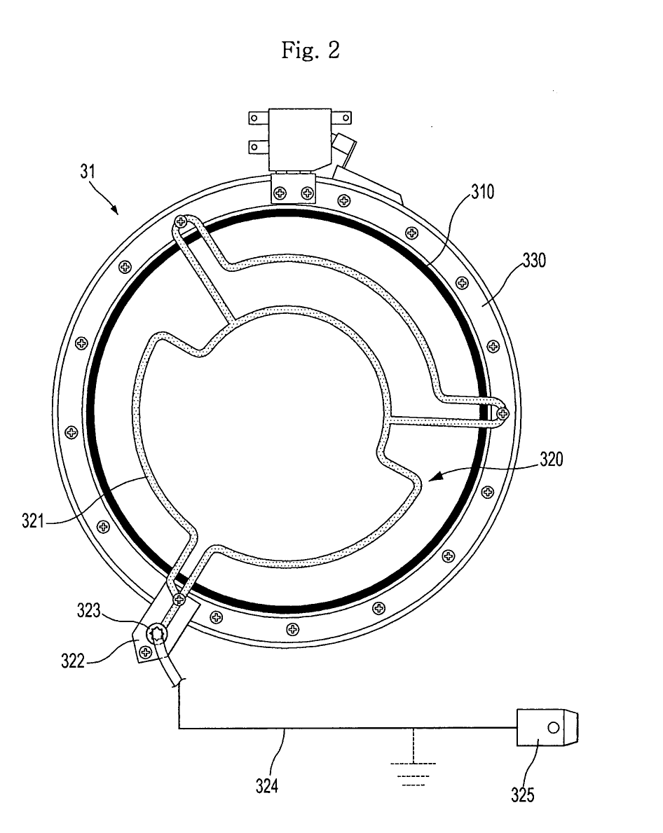

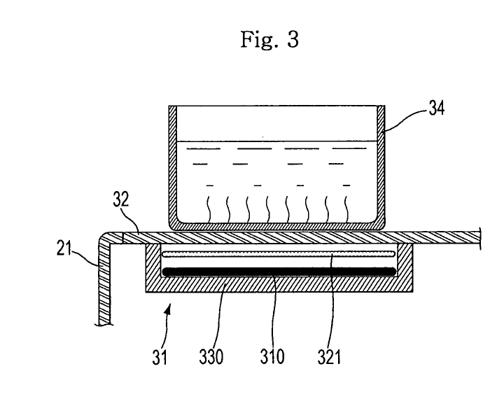

FIG. 2 shows a plan view of the heat generation unit having the pan sensor according to the present invention. FIG. 3 shows a cross sectional view of the heat generation unit having the pan sensor installed in the cooking range according to the present invention.

Referring to FIGS. 2 and 3, the heat generation unit 31 includes a radiant heater 310, a pan sensor 320 combined to an upper portion of the radiant heater 310, and a heater frame 330 formed of a thermal insulator and provided at the outside of the radiant heater 310 to surround the radiant heater 310.

Generally, the radiant heater 310 is a heater formed in a ribbon shape.

The pan sensor 320 is a capacitive sensor for transmitting a signal in reaction with the cooking pan 34 having an electrostatic capacitance to detect whether the cooking pan 34 is mounted on the top plate 32. The pan sensor 320 is a switching device for sensing change between the high-level and low-level signals through contact with the cooking pan 34.

The pan sensor 320 includes a sensor ring 321 for detecting an electrostatic capacitance value depending on whether the cooking pan 34 is mounted and a sensor supporting unit 322 connected to the sensor ring 321. Combination screws are inserted into the sensor supporting unit 322 to fix the pan sensor 320 to the radiant heater 310 and insulate therebetween. The sensor ring 321 having an induction electrode directly or indirectly detects mounting of the cooking pan 34 and transmits variation in the electrostatic capacitance to a signal transmission unit 325 through a lead wire 324 connected to a terminal 323. In this case, the lead wire 324 should be electrically connected to ground potential by using a shielded wire. Further, the sensor ring 321 is a digital on/off switching device, which outputs the high-level signal when the cooking pan 34 is mounted and outputs the low-level signal when the cooking pan 34 is not mounted according to variation in the electrostatic capacitance, to detect mounting of the cooking pan 34.

The sensor ring 321 is a sensor coil formed in a multi-arc shape, which covers a heat generation region of the radiant heater 310, so that mounting of the cooking pan 34 can be stably detected regardless of the location of the cooking pan 34 when the cooking pan 34 is mounted on the top plate 32.

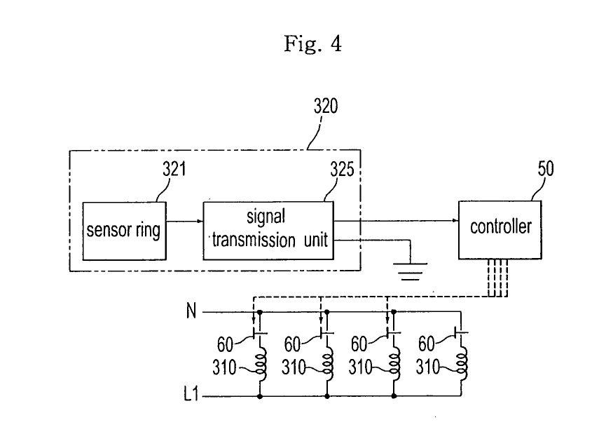

FIG. 4 shows a circuit configuration of the cooking range having the heat generation unit according to the present invention. In FIG. 4, reference numerals 50 and 60 represent a controller and a power supply relay, respectively.

The controller 50 is a main printed circuit board (PCB) for controlling respective units of the cooking range 10 according to cooking information selected by the control nobs 42. The controller 50 detects whether the cooking pan 34 is mounted on the top plate 32 based on high-level or low-level sensor output signals transmitted from the pan sensor 320.

In this case, the controller 50 determines whether power is supplied to the radiant heater 310 by checking a signal output value of the pan sensor 320. When the pan sensor 320 detects that the cooking pan 34 is not mounted, the controller 50 outputs a control signal for blocking power supplied to the radiant heater 310. When the pan sensor 320 detects that the cooking pan 34 is mounted, the controller 50 outputs a control signal for supplying power to the radiant heater 310 to start a cooking operation.

The power supply relay 60 performs an on/off operation for supplying power to the radiant heater 310 or blocking power supplied thereto according to the control signal outputted from the controller 50. A plurality of power supply relays is provided according to the number of the heat generation units 31 disposed on the top plate 32, so that each relay is operated on/off according to the signal output value of the pan sensor 320 provided in each heat generation unit 31.

Hereinafter, there will be described an operation process and effect of a control method of the cooking range having the heat generation unit having the pan sensor.

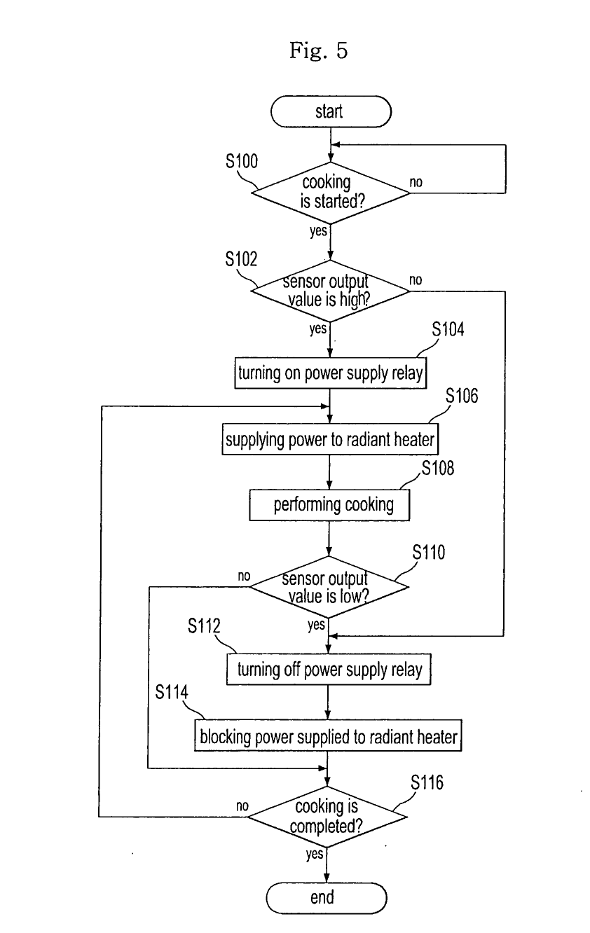

FIG. 5 is a flowchart showing an operation process of controlling power supply depending on whether the cooking pan is mounted in the cooking range having the heat generation unit according to the present invention.

The cooking pan 34 containing food is mounted on the top plate 32 and the user selects desired cooking information (cooking the food using the cooktop unit) by controlling the control knobs 42. Then, the cooking information selected by the user is inputted to the controller 50.

Then, the controller 50 starts cooking according to the cooking information selected by controlling the control knobs 42. First, the controller 50 determines whether cooking has started (S100).

If it is determined that cooking has started, the controller 50 receives the high-level or low-level sensor output value transmitted from the pan sensor 320 to determine whether the cooking pan 34 is mounted on the top plate 32 before the cooking is performed.

When the pan sensor 320 detects mounting of the cooking pan 34, the sensor ring 321, having an induction electrode of the pan sensor 320, directly or indirectly detects mounting of the cooking pan 34. That is, the sensor ring 321 outputs the high-level signal when the cooking pan 34 is mounted and outputs the low-level signal when the cooking pan 34 is not mounted in reaction with the cooking pan 34 having the electrostatic capacitance.

The high-level or low-level signal outputted from the sensor ring 321 is transmitted to the signal transmission unit 325 through the lead wire 324 connected to the terminal 323. The sensor output value transmitted to signal transmission unit 325 is inputted tot the controller 50.

The controller 50 determines whether the sensor output value is high (S102). If it is determined that the sensor output value is high, the controller 50 detects that the cooking pan 34 is mounted on the top plate 32 and turns on the power supply relay 60 (S104) to supply power to the radiant heater 310 (S106).

When the cooking pan 34 is mounted on the top plate 32, the radiant heater 310 is operated by supplying power to the radiant heater 310 to perform the cooking of food contained in the cooking pan 34 (S108).

While the cooking is performed by the operation of the radiant heater 310, if the cooking pan 34 is taken away from the top plate 32 in a power-on state, the pan sensor 320 detects that the cooking pan 34 is taken away and transmits the low-level sensor output value to the controller 50.

The controller 50 determines whether the sensor output value is low (S110). If it is determined that the sensor output value is low, namely when the cooking pan 34 is not mounted on the top plate 32, the controller 50 detects that the cooking pan 34 is not mounted on the top plate 32. Then, the controller 50 turns off the power supply relay 60 (S112) to block power supplied to the radiant heater 310 (S114).

As described above, while the cooking is performed by using the radiant heater 310, the pan sensor 320 having the sensor ring 321 can stably detect whether the cooking pan 34 is mounted on the top plate 32 without error by using a simple circuit configuration. Thus, it is possible to stably control power supplied to the radiant heater 310.

Then, it is determined whether the cooking using the radiant heater 310 is completed (S116). If it is determined that the cooking is completed, the operation is completed by blocking power supplied to the radiant heater 310.

If it is determined that the cooking is not completed at operation S116, the process returns to operation S106 in order to check whether the cooking pan 34 is taken away from the top plate 32 in a power-on state while the cooking is performed by the operation of the radiant heater 310. The pan sensor 320 always and stably detects whether the cooking pan 34 is mounted such that power supplied to the radiant heater 310 is stably controlled.

On the other hand, If it is determined that the sensor output value is low at operation S102, namely when the cooking pan 34 is not mounted on the top plate 32, the controller 50 determines that a range cooktop cooking using the radiant heater 310 is selected while the cooking pan 34 is not mounted and the process proceeds to operation S112, wherein the power supply relay 60 is turned off to block power supplied to the radiant heater 310.

As described above, according to the present invention, there is provided a pan sensor which outputs a signal by a digital on/off operation, a heat generation unit having the pan sensor, a cooking range having the heat generation unit and a control method thereof. Therefore, mounting of a cooking pan can be stably detected without error by using a simple circuit configuration.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A pan sensor comprising:
a sensor supporting unit installed in a radiant heater for supplying heat to a pan; and
a detection unit connected to the sensor supporting unit to detect the pan and to generate a sensing signal if the pan is detected, the detection unit having a sensor ring to sense the presence of the pan.

2. The pan sensor according to claim 1, wherein the sensor ring senses the presence of the pan by detecting variation in electrostatic capacitance through contact with the pan.

3. The pan sensor according to claim 2, wherein the sensor ring includes a sensor coil formed in a multi-arc shape to cover the radiant heater.

4. The pan sensor according to claim 2, wherein the pan sensor is a digital on/off switch for outputting a high-level or low-level sensor output value according to the variation in electrostatic capacitance.

5. The pan sensor according to claim 4, further comprising:
a lead wire for transmitting the high-level or low-level sensor output value according to the variation in electrostatic capacitance.

6. The pan sensor according to claim 5, wherein the lead wire is electrically connected to ground potential by using a shielded wire.

7. The pan sensor according to claim 5, further comprising:
a terminal for connecting the sensor ring with the lead wire.

8. A heat generation unit comprising:
a cooking pan;
a radiant heater for supplying heat to the cooking pan; and
a pan sensor installed in the radiant heater to sense whether the cooking pan is mounted above the radiant heater, the pan sensor having a sensor ring for detecting variation in electrostatic capacitance depending on whether the cooking pan is mounted above the radiant heater.

9. The heat generation unit according to claim 8, wherein the pan sensor outputs a high-level or low-level sensor output value according to variation in electrostatic capacitance by electrically connecting the sensor ring to ground potential.

10. A cooking range comprising:
a top plate for mounting a cooking pan thereon;
one or more radiant heaters installed in the top plate for supplying heat to the cooking pan;
one or more pan sensors, respectively installed in the radiant heaters, for sensing the cooking pan, each pan sensor having a sensor ring for detecting variation in electrostatic capacitance depending on whether the cooking pan is mounted above the radiant heater; and
a controller for controlling each radiant heater based on a sensor output value of each pan sensor.

11. The cooking range according to claim 10, wherein the pan sensor outputs a high-level or low-level sensor output value according to variation in electrostatic capacitance by electrically connecting the sensor ring to ground potential set in the cooking range.

12. The cooking range according to claim 10, wherein the pan sensor includes a signal transmission unit for transmitting the high-level or low-level sensor output value corresponding to the variation in electrostatic capacitance to the controller.

13. The cooking range according to claim 10, wherein the pan sensors are installed in proportion to the number of the radiant heaters installed in the top plate, and each pan sensor provided in each radiant heater is independently operated.

14. The cooking range according to claim 10, wherein the controller determines whether the cooking pan is mounted on the top plate based on the sensor output value of the pan sensor to control an operation of supplying power to the radiant heater.

15. The cooking range according to claim 14, wherein when the pan sensor senses that there is the cooking pan, the controller outputs a control signal for supplying power to the radiant heater to perform a cooking operation.

16. The cooking range according to claim 14, wherein when the pan sensor senses that there is not the cooking pan, the controller outputs a control signal for blocking power supplied to the radiant heater to stop a cooking operation.

17. The cooking range according to claims 15 or 16, further comprising:
one or more power supply relays for performing an on/off operation according to the control signal outputted from the controller to supply power to the radiant heater or block power supplied to the radiant heater.

18. The cooking range according to claim 17, wherein the power supply relays are installed in proportion to the number of the radiant heaters installed in the top plate, and each power supply relay is independently operated according to a signal output value of the pan sensor provided in each radiant heater.

19. A control method of a cooking range including a cooking pan, a top plate, a radiant heater, a pan sensor and a controller, the method comprising:
sensing whether the cooking pan is mounted on the top plate by a pan sensor;
supplying power to the radiant heater by the controller to perform a cooking operation when sensing that the cooking pan is mounted; and
blocking power supplied to the radiant heater by the controller to stop the cooking operation when sensing that the cooking pan is not mounted while the cooking operation is operated.

20. The control method according to claim 19, wherein the sensing includes:
detecting variation in electrostatic capacitance depending on whether there is the cooking pan in the pan sensor having a sensor ring to output a high-level or low-level sensor output value.

21. The control method according to claim 20, wherein the sensing includes:
outputting a high-level or low-level sensor output value according to variation in electrostatic capacitance by electrically connecting the sensor ring to ground potential set in the cooking range.
